(19) United States
(12) Patent Application Publication
(10) Pub. No.: US 2025/0198221 A1
(43) Pub. Date: Jun. 19, 2025

(54) METHOD FOR OPERATING A MOTORISED FLAP ARRANGEMENT OF A MOTOR VEHICLE

(71) Applicant: Brose Fahrzeugteile SE & Co. Kommanditgesellschaft, Bamberg, Bamberg (DE)

(72) Inventors: Michael Wuest, Muhr am See (DE); Julian Adametz, Nuemberg (DE); Christopher Trenkle, Bamberg (DE); Wolfgang Uebel, Weitramsdorf (DE); Benjamin Gruenewald, Hassfurt/Augsfeld (DE); Sergej Gauerhof, Knetzgau (DE); Martin Halbig, Viereth (DE); Syed Imad Ud Din, Bamberg (DE); Matthias Ruppert, Zeegendorf (DE); Carsten Topf, Schonungen (DE)

(21) Appl. No.: 18/567,566

(22) PCT Filed: Jun. 7, 2022
(86) PCT No.: PCT/EP2022/065356

§ 371 Date: Jun. 21, 2024

(30) Foreign Application Priority Data
Jun. 7, 2021 (DE) 10 2021 114 557.0

(51) Int. Cl. E05F 15/76; B60R 25/31; E05F 15/603

(52) U.S. Cl. CPC E05F 15/76; B60R 25/31; E05F 15/603; E05Y 2400/852; E05Y 2400/858; E05Y 2900/531

(57) ABSTRACT

Various embodiments relate to a method for operating a flap arrangement, wherein a control arrangement for activating a motorized drive arrangement assigned to the flap arrangement and a radar sensor coupled to the control arrangement are provided, wherein sensor values relating to a user action of a user situated outside of the motor vehicle are detected by the radar sensor, wherein the detected sensor values are checked, by the control arrangement, for the fulfillment of prescribed user action criteria, wherein, depending on the result of the check, the user action detected via the sensor values is rejected or is qualified as a valid user action, and wherein, upon detection of a valid user action, the control arrangement activates the drive arrangement for the motorized displacement of the flap arrangement. It is proposed that, a time-dependent association of detected sensor values with the user is performed by means of the control arrangement.

### CROSS-REFERENCE TO RELATED APPLICATIONS

This application is a national stage application under 35 U.S.C. 371 of International Patent Application Serial No. PCT/EP2022/065356, entitled “METHOD FOR OPERATING A MOTORISED FLAP ARRANGEMENT OF A MOTOR VEHICLE,” filed Jun. 7, 2022, which claims priority from German Patent Application No. DE 10 2021 114 557.0, filed Jun. 7, 2021, the disclosure of which is incorporated herein by reference.

### FIELD OF THE TECHNOLOGY

Various embodiments relate to a method for operating a motorized flap arrangement of a motor vehicle, a control arrangement for a motorized flap arrangement of a motor vehicle and a motor vehicle for carrying out such a method.

### BACKGROUND

In the known method (DE 10 2018 121 346 A1), which various embodiment use as a starting point, operation of the flap is provided via a predefined user action which is defined by an actuation movement introduced manually into the flap. An actuation detected as a valid user action is additionally checked for plausibility by the detection of the user in the vicinity of the motor vehicle, in particular by means of a radar sensor, in order to reduce the probability of an erroneous activation.

Another known method (DE 101 06 400 B4) provides for the tracking of a transponder carried by the user. The user action for actuating the flap arrangement is prescribed by the fact that the user approaches the motor vehicle and remains standing in front of the flap.

### SUMMARY

To increase comfort when actuating the flap, it is advantageous to further simplify the actuation action that the user must perform. It can also be possible for a user to operate the flap arrangement intuitively while keeping the hands free. At the same time, the probability of erroneous activation should be kept low.

Various embodiments are based on the problem of configuring and developing the known method in such a way that the actuation of the flap arrangement is simplified further.

The above problem is solved with a method in accordance with features disclosed herein.

The flap arrangement under discussion has a flap that is adjustable by motor. The flap can be any closure element of a motor vehicle. This includes tailgates, trunk lids, front hoods, especially engine hoods, doors, especially side doors or rear doors or the like. The flap can be arranged on the motor vehicle bodywork in a pivotable or longitudinally displaceable manner.

The essential point for some embodiments is the basic consideration that radar sensors of motor vehicles, which are provided for monitoring the driving mode, for example, can be employed for reliable tracking of a user in the vicinity of the motor vehicle. User tracking via radar sensors allows the path of movement of the user to be determined with a high degree of accuracy as a basis for recognizing a valid approach of the user for triggering the motorized displacement.

Specifically it is proposed that, in a user tracking routine, a time-dependent association of detected sensor values with the user is performed by means of the control arrangement, a user trajectory for the position of the user is determined from the time dependence of the sensor values associated with the user, and at least one user action criterion is defined by the fact that the user trajectory complies with a trajectory specification.

It was recognized that, by verifying the user trajectory determined in this way, it is possible to distinguish, with a high degree of certainty, between an intentional approach of the user toward the flap arrangement, with said user wishing to actuate it, and, for example, an unintentional passing by of a person.

Effective monitoring of the vicinity of the motor vehicle via the radar sensor is achieved in some embodiments via a needs-based triggering of the user tracking routine using a user recognition criterion. In various embodiments, excessively frequent triggering of the user tracking routine is avoided, in particular, by taking into account an expansion specification, for instance the size of the detected object, and/or speed values.

A further improvement of the user tracking, and therefore of the determined user trajectory, is produced by a configuration in accordance with some embodiments by combining radar targets to form a common cluster target, which is taken into consideration in the user tracking routine.

In various embodiments, the trajectory specification is defined using an approach area portion. A particularly simple and reliable recognition of an intentional approach of the user is made possible in particular by verifying that prescribed approach windows in the approach area portion have been passed through. Further safeguarding against erroneous triggering is achieved by taking into account a maximum approach period in various embodiments.

In various embodiments, in addition to the approach area portion, a confirmation area portion is prescribed in which passing through the approach area portion in accordance with the trajectory specification can be further validated. For example, an additional check is made for the presence of a stopping motion in the confirmation area portion.

The definition of different approach area portions for a plurality of flap arrangements is used in the configuration in accordance with various embodiments for the purpose of selectively activating the flap arrangement targeted by the user.

Various embodiments relate to the carrying out of the user tracking routine on the basis of a mathematical estimation model, which can increase the accuracy of the determined user trajectory. The probability of an erroneous assignment of radar targets in the user tracking routine, for instance if several persons are located in the vicinity of the motor vehicle, can be reduced in this way.

Additional safeguarding against unauthorized access to the motor vehicle is achieved in the configuration in various embodiments by the detection of an authentication unit of the user, for instance the request of an electronic key. In various embodiments, the detection of the authentication unit can be employed to trigger the monitoring of the vicinity via the radar sensor, in order to reduce the energy consumption of the method. In various embodiments, double use of the detection of the authentication unit consists in taking a position value determined by the detection of the authentication unit into account in the user recognition criterion, which also makes the user tracking routine more reliable.

In various embodiments, a radar sensor already provided for the driving mode and/or for collision protection during the motorized displacement is used to monitor the vicinity to detect the actuation action, and therefore additional sensor technology is not necessarily required for carrying out the proposed method.

Various embodiments relate to the recognition of a prescribed user gesture which can represent a satisfactory user action criterion for triggering the motorized displacement. Consequently, the user can alternatively make use of gesture control for the actuation, for example if the approach of the user has been delayed.

According to various embodiments, a control arrangement for a motorized flap arrangement of a motor vehicle is provided. In this case, the control arrangement takes over the evaluation of the sensor values in the user tracking routine. Reference is made to all statements relating to the proposed method.

According to various embodiments, a motor vehicle for carrying out the proposed method is provided. In this respect, reference is also made to all statements relating to the proposed method and to the proposed control arrangement.

Various embodiments provide a method for operating a motorized flap arrangement of a motor vehicle, wherein a control arrangement for activating a motorized drive arrangement assigned to the flap arrangement and a radar sensor coupled to the control arrangement are provided, wherein sensor values relating to a user action of a user situated outside of the motor vehicle are detected by means of the radar sensor, wherein the detected sensor values are checked, by means of the control arrangement, for the fulfillment of prescribed user action criteria, wherein, depending on the result of the check, the user action detected via the sensor values is rejected or is qualified as a valid user action, and wherein, upon detection of a valid user action, the control arrangement activates the drive arrangement for the motorized displacement of the flap arrangement, wherein, in a user tracking routine, a time-dependent association of detected sensor values with the user is performed by means of the control arrangement, a user trajectory for the position of the user is determined from the time dependence of the sensor values associated with the user, and at least one user action criterion is defined by the fact that the user trajectory complies with a trajectory specification.

In various embodiments, the user tracking routine is triggered upon fulfillment of a prescribed user recognition criterion. In some embodiments, the user recognition criterion is at least partially defined by the fact that the object detected via the sensor values complies with an expansion specification representative of a user, such as a minimum size and/or a prescribed outline.

In various embodiments, the user recognition criterion is at least partially defined by the fact that speed values of an object detected in the sensor values represent a prescribed approach toward the motor vehicle. In some embodiments, the speed values represent an approach exceeding a prescribed minimum speed.

In various embodiments, in the user tracking routine, a plurality of radar targets detected in the sensor values are combined in accordance with a cluster model to form a cluster target, the cluster target is associated with the user in a time-dependent manner and the user trajectory is determined on the basis of the cluster target. In some embodiments, the cluster model is based on the determination of a cluster target using statistical values of radar targets, further, in some embodiments, selected using position values, amplitude values and/or speed values.

In various embodiments, the trajectory specification is at least partially defined by the fact that the user trajectory runs within a prescribed approach area portion at least over a period of time. In some embodiments, the user trajectory passes through at least two prescribed approach windows of the approach area portion.

In various embodiments, the trajectory specification is at least partially defined by the fact that the approach area portion, such as the approach windows, is or are passed through by the user trajectory within a prescribed approach period.

In various embodiments, a confirmation area portion is provided between the motor vehicle and the approach area portion and the trajectory specification meets the user trajectory in the approach area portion. In some embodiments, the trajectory specification is at least partially defined by the fact that the user trajectory experiences a stopping motion in the confirmation area portion. In some embodiments, a maximum speed is not reached and/or a minimum residence time in the confirmation area portion is exceeded.

In various embodiments, a plurality of motorized flap arrangements are provided, for which an approach area portion is prescribed in each case, and, with the qualification as a valid user action, using the user trajectory and the approach area portions the user action is assigned to one of the flap arrangements for the motorized displacement.

In various embodiments, in the user tracking routine, the detected, time-dependent sensor values are associated with the user on the basis of a mathematical estimation model. In some embodiments, the estimation model is based on an alpha-beta filter, a Kalman filter and/or a nonlinear filter.

In various embodiments, one of the actuation criteria is defined by the fact that an authentication unit, in particular an electronic key, of the user is detected by means of the control arrangement. In some embodiments, the detection of the sensor values by means of the control arrangement is triggered upon detection of the authentication unit, and/or that the user recognition criterion is at least partially defined by the fact that a position value, determined from the sensor values of the radar sensor, of the object detected in the sensor values corresponds to a position value of the authentication unit determined by the detection of the authentication unit.

In various embodiments, the radar sensor is designed for a vehicle-to-X application. In some embodiments, the radar sensor is designed for a vehicle-to-vehicle application in the driving mode and is used for detecting the sensor values relating to the user action when the motor vehicle is parked, and/or the radar sensor is designed to detect objects in the displacement region of the motorized displacement of the flap arrangement.

In various embodiments, one of the user action criteria, in particular a user action criterion sufficient for qualification as a valid user action, relates to the recognition of a prescribed user gesture. In some embodiments, the prescribed user gesture is to be carried out after the approach area portion has been walked through, in particular in the confirmation area portion.

Various embodiments provide a control arrangement for a motorized flap arrangement of a motor vehicle, wherein the control arrangement is designed to activate a motorized drive arrangement assigned to the flap arrangement and to couple to a radar sensor, wherein the radar sensor detects sensor values relating to a user action of a user situated outside of the motor vehicle, wherein the control arrangement checks the detected sensor values for the fulfillment of prescribed user action criteria and, depending on the result of the check, rejects the user action detected via the sensor values or qualifies it as a valid user action, and wherein, upon detection of a valid user action, the control arrangement activates the drive arrangement for the motorized displacement of the flap arrangement, wherein, in a user tracking routine, the control arrangement performs a time-dependent association of detected sensor values with the user, the control arrangement determines a user trajectory for the position of the user from the time dependence of the sensor values associated with the user, and at least one user action criterion is defined by the fact that the user trajectory complies with a trajectory specification.

Various embodiments provide a motor vehicle for carrying out the method as described herein.

### BRIEF DESCRIPTION OF THE DRAWINGS

Various aspects are explained in more detail below, with reference to a drawing that represents merely one exemplary embodiment. In the drawing

FIG. 1 shows a proposed motor vehicle having a proposed flap arrangement for carrying out the proposed method in a plan view, and

FIG. 2 shows a diagrammatic time dependence of radar targets during approach of a user toward the motor vehicle.

### DETAILED DESCRIPTION

The proposed method relates to the operation of a motorized flap arrangement 1 of a motor vehicle 2. A control arrangement 3 serves to activate a motorized drive arrangement 4 assigned to the flap arrangement 1.

In the depicted embodiment and other various embodiments, the drive arrangement 4 is provided for transferring the flap 5 of the flap arrangement 2 from a closed position to an open position. A transfer from an open position into a closed position can also be provided. In principle, the drive arrangement 4 can also bring about other motorized displacement functions of the flap arrangement 1, for example an unlocking and/or opening of a motor vehicle lock assigned to the flap 5. For possible configurations of the flap 5, reference is made to the introductory statements, the flap 5 here being depicted as a side door by way of example.

An electronic radar sensor 6 is coupled to the control arrangement 3, wherein sensor values relating to a user action of a user B situated outside of the motor vehicle 2 are detected by means of the radar sensor 6. In various embodiments, the radar sensor 6 has a plurality of sensor units which are arranged in particular in a distributed manner on the motor vehicle 2, in order to monitor the vicinity of the motor vehicle 2.

The sensor units have antenna arrangements which can be equipped with one or more antenna arrays which are arranged in particular in a prescribed angular position and location in relation to one another. Here, in various embodiments, the radar sensor 6 carries out a continuous, further frequency modulated, distance measurement and direction measurement, for instance as an FMCW radar sensor. The radar sensor 6 can be designed for operation with radar radiation in the frequency band around 24 GHz and/or 77 GHz. The sensor values are representative of the position of objects outside of the motor vehicle 2. For example, the sensor values contain an item of information on the distance and an item of information on the direction between the detected object, here the user B, and the motor vehicle 2. In various embodiments, the sensor values additionally contain an item of information on the speed, for instance an item of Doppler information, of the object, here the user B.

The detected sensor values are checked, by means of the control arrangement 3, for the fulfillment of prescribed user action criteria, wherein, depending on the result of the check, the user action detected via the sensor values is rejected or is qualified as a valid user action. A user action is generally understood here to mean a movement of the user B, in particular a movement of the entire user B such as an approach and/or the movement of a body part of the user B. Upon detection of a valid user action G, the control arrangement 3 activates the drive arrangement 4 for the motorized displacement of the flap arrangement 1.

In a monitoring operation, the sensor values are checked here by means of the control arrangement 3 for the fulfillment of the user action criteria. For example, on this basis a degree of fulfillment is determined, wherein, depending on the determined degree of fulfillment, the detected user action is rejected or is qualified as a valid user action. The first case mentioned results in no activation of the drive arrangement 4. In the second case mentioned, the drive arrangement 4 is activated by means of the control arrangement 3. Individual user action criteria can also be defined as user action criteria which are sufficient or necessary for the activation.

The essential point now is that a time-dependent association of detected sensor values with the user B is performed by means of the control arrangement 3 in a user tracking routine, that a user trajectory for the position of the user B is determined from the time dependence of the sensor values associated with the user B, and that at least one user action criterion is defined by the fact that the user trajectory complies with a trajectory specification.

The user trajectory represents a path curve on which the user B moves relative to the motor vehicle 2 in accordance with the sensor values and indicates the position of the user B as a function of time t, at least at discrete points in time. The position of the user is understood here to mean the location of the entire body of the user B. In the drawing, the user trajectory is depicted, by way of example, as a path curve x(t), y(t) in a Cartesian coordinate system 7, but other representations of the user trajectory are conceivable.

To determine the user trajectory, a time-dependent association of detected sensor values is performed. In this case, radar targets can be identified in the sensor values, in particular using the intensity of the reflected radar waves and in some embodiments by exceeding a prescribed intensity threshold. In the user tracking routine, individual ones of these radar targets are associated with the user, wherein the path of movement of these radar targets is determined in a temporal sequence of sensor values.

The trajectory specification is generally representative of user trajectories that correspond to a valid approach toward the motor vehicle 2 by the user B in order to trigger the motorized displacement. In various embodiments, the trajectory specification contains at least one specification relating to position and at least one specification relating to time.

In various embodiments, the user tracking routine is triggered upon fulfillment of a prescribed user recognition criterion. With the triggering of the user tracking routine, a first association of radar targets with the user B can be performed, wherein these radar targets are subsequently tracked to determine the user trajectory. In various embodiments, the user recognition criterion is at least partially defined by the fact that the object detected via the sensor values complies with an expansion specification representative of a user. In this case, the sensor values make it possible to not only identify the position of an object but also to draw a conclusion as to the size and/or shape of the object, so that a person can be distinguished from other objects with a high degree of probability.

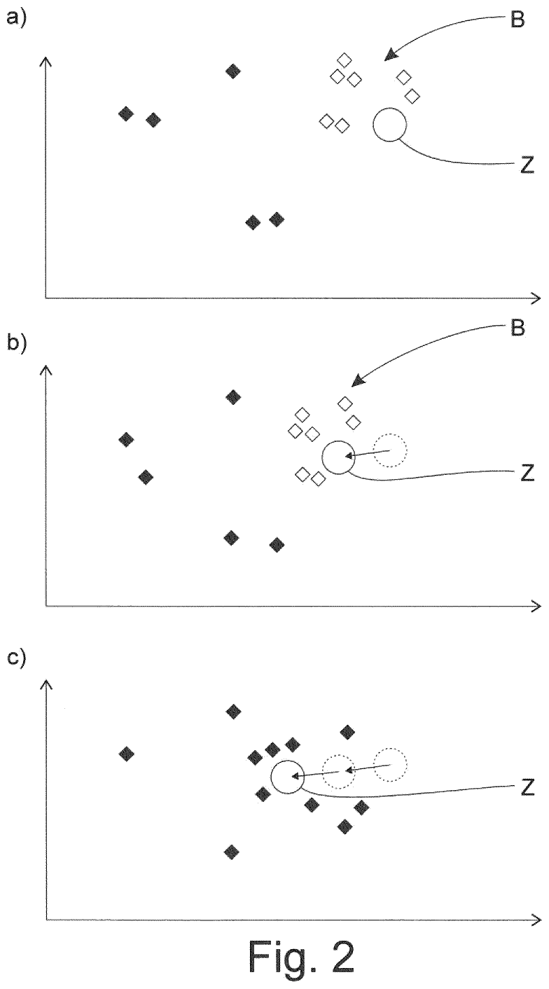

In various embodiments, the expansion specification contains a minimum size and/or a prescribed outline of the object. By way of example, FIG. 2a) shows different radar targets from the viewpoint of the radar sensor 6 as a function of the detection angle, but the distance values are not shown. Using the size and outline of the detected object, individual radar targets are associated with the user B and the user tracking routine is triggered.

In various embodiments, the user recognition criterion is at least partially defined by the fact that speed values of an object detected in the sensor values represent a prescribed approach toward the motor vehicle. Consequently, it is possible in turn to distinguish between objects approaching the motor vehicle and stationary or departing objects, so that the probability of erroneous triggering is reduced.

In a particularly simple configuration, the user recognition criterion is at least partially defined by the fact that the speed values represent an approach exceeding a prescribed minimum speed. In various embodiments, the speed values are produced from an item of Doppler information relating to the object and/or from a time dependence of the position of the object. In FIG. 2a), radar targets with speed values in the direction of the motor vehicle 2 are depicted with open symbols, whereas stationary radar targets are shown with closed symbols. In this case, the radar targets with speed values that show an approach toward the motor vehicle 2 at a prescribed minimum speed are associated with the user B, and the user tracking routine is triggered.

In the user tracking routine, in various embodiments, a plurality of radar targets detected in the sensor values are combined in accordance with a cluster model to form a cluster target Z. The cluster target Z is associated in a time-dependent manner with the user B and the user trajectory is determined on the basis of the cluster target Z. By way of example, FIGS. 2a), b), c) show the detected radar targets at three different points in time and the resulting time dependence of the position of the cluster target Z.

In various embodiments, the cluster model is based on the determination of a cluster target Z using statistical values. To determine the statistical values, different statistical functions can be employed, such as statistical mean values such as a geometric center, in this case the centroid of volume, of the radar targets to be assigned to the user B.

As already mentioned, the radar targets can be selected using position values, amplitude values and/or speed values. In this case, the amplitude values are understood to mean the intensity of the reflected radar waves. The radar targets can be selected using speed values for determining the cluster target Z, for example depending on whether the radar targets approach the motor vehicle 2 in a predetermined manner, for instance at a prescribed minimum speed.

In various embodiments, it is envisioned that the trajectory specification is at least partially defined by the fact that the user trajectory runs within a prescribed approach area portion 8 at least over a period of time. In this case, it can be prescribed which regions of the approach area portion 8 should runthrough the user trajectory at which points in time. The trajectory specification can also include the provision that a prescribed minimum proportion, for example a minimum proportion of the traveled route of the user trajectory, or the entire user trajectory runs within the approach area portion 8.

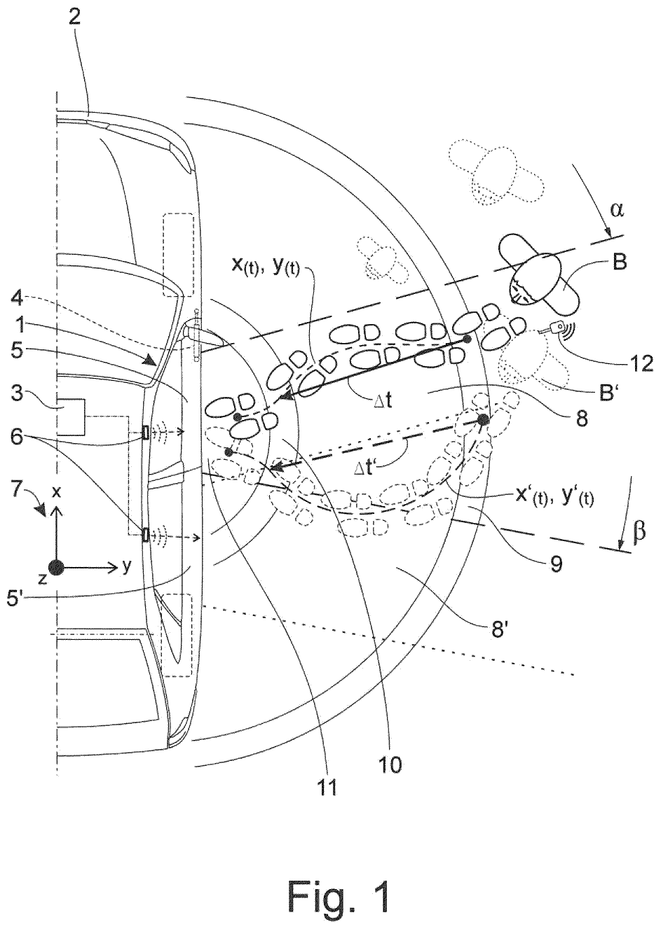

In a particularly simple configuration, it is envisioned that the trajectory specification is at least partially defined by the fact that the user trajectory passes through at least two prescribed approach windows 9, 10 of the approach area portion 8. The approach windows can be approximately two-dimensional entities. In FIG. 1 and in accordance with various embodiments, the approach windows 9, 10 are configured as expanses approximately in the shape of a spherical segment in the approach area portion 8, whereby it is checked, for example, whether the user B is situated in a prescribed angular range a, B at the distances from the motor vehicle 2 which correspond to the approach windows 9, 10.

In various embodiments, the trajectory specification is at least partially defined by the fact that the approach area portion 8, such as the approach windows 9, 10, is or are passed through by the user trajectory within a prescribed approach time interval Δt. Accordingly, the user B must approach the motor vehicle 2 quickly enough through the approach area portion 8 in order to trigger a displacement.

In the configuration shown here in FIG. 1, it may be sufficient for the user B to pass through the two approach windows 9, 10 within the approach time interval Δt, wherein the user B can also leave the approach area portion 8 temporarily, which is indicated by the user trajectory x′(t), y′(t) shown in dashes. In an alternative configuration, the trajectory specification prescribes that the approach area portion 8 cannot be left, and so in this case only the trajectory x(t), y(t) denoted by a solid line complies with the trajectory specification.

In accordance with a further configuration, a confirmation area portion 11 is provided between the motor vehicle 2 and the approach area portion 8. Here, the trajectory specification meets the user trajectory in the approach portion 8. The trajectory specification can be at least partially defined by the fact that the user trajectory experiences a stopping motion in the confirmation area portion 11. In some embodiments, a maximum speed is not reached and/or a minimum residence time in the confirmation area portion 11 is exceeded. The stopping motion here can represent an additional criterion of the trajectory specification to the already explained monitoring of the approach area portion 8. The stopping motion can be used to infer with a high degree of certainty that the detected user B wishes to perform an actuation.

In general, a plurality of motorized flap arrangements 1 can be provided which have flaps 5 in each case. For the flap arrangements 1, in each case an approach area portion 8 can be prescribed, which is shown additionally in FIG. 1 using an approach area portion 8′ for the rear door 5′. With the qualification as a valid user action, using the user trajectory and the approach area portions 8, 8′ the user action is assigned to one of the flap arrangements for the motorized displacement. Depending on which flap 5, 5′ the user B is approaching by way of a user trajectory in accordance with the trajectory specification, in this case the corresponding flap 5, 5′ is actuated in a motorized manner.

In the user tracking routine, the detected, time-dependent sensor values can be associated with the user on the basis of a mathematical estimation model. The sensor values are used in the present case to generate a prediction for the radar targets in FIG. 2a) regarding the positions at which the radar targets will be located at the later point in time shown in FIG. 2b). The association of the radar targets at the later point in time is performed using the prediction. Different, inherently known methods can be employed for the mathematical estimation model. In various embodiments, the estimation model is based on an alpha-beta filter, a Kalman filter and/or a nonlinear filter.

In accordance with a further configuration, one of the actuation criteria is defined by the fact that an authentication unit 12, in particular an electronic key, of the user B is detected by means of the control arrangement 3. For this purpose, the control arrangement 3 can be coupled to a transceiver unit, not shown, which communicates with a transponder in the authentication unit 12. In this case, the presence of the authentication unit 12 can be a necessary prerequisite for the triggering of the displacement.

In various embodiments, it is envisioned that the detection of the sensor values by means of the control arrangement 3 is triggered upon detection of the authentication unit 12. In particular, the transceiver unit can have a greater range for the authentication unit 12 than the radar sensor 6. An initial approach of the user B carrying the authentication unit 12 is thus first recognized via the detection of the authentication unit 12. The radar sensor 6 can then be operated in order to detect the user B via the sensor values and to perform the user tracking routine.

The detection of the authentication unit 12 can also allow identification of the position, in particular the direction, of the user B to take place. In accordance with a further configuration, the user recognition criterion is at least partially defined by the fact that a position value, determined from the sensor values of the radar sensor 6, of the object detected in the sensor values corresponds to a position value of the authentication unit 12 determined by the detection of the authentication unit 12. Radar targets identified in the sensor values can be associated with the user B by matching with the position of the authentication unit 12.

The radar sensor 6 can be designed for a vehicle-to-X application and, in addition to the detection of the user action, it can also be used for further functions relating to the driving mode of the motor vehicle 2, for example. The radar sensor 6 can be designed for a vehicle-to-vehicle application in the driving mode, for example for autonomous or partially autonomous motor vehicles 2. In the case of a parked motor vehicle 2, the radar sensor 6 is used in the context of the proposed method for detecting the sensor values relating to the user action.

The radar sensor 6 can also be designed to detect objects in the displacement region of the motorized displacement of the flap arrangement. In this configuration, in addition to the detection of user actions, the radar sensor 6 serves to recognize obstructions and/or protect against pinching or jamming in the motorized displacement.

In a further configuration, one of the user action criteria relates to the recognition of a prescribed user gesture. The user gesture is, for example, a prescribed hand movement such as a swiping movement and/or a foot movement such as a kicking movement of the user B.

In particular, the user action criterion relating to the user gesture is a user action criterion that is sufficient to qualify as a valid user action, which means that the user has access to a further possibility for triggering the displacement by way of the user gesture when said user deviates from the trajectory specification. Alternatively, the implementation of the user gesture can, however, also be required in combination with compliance with the user trajectory for triggering the displacement. It can be provided to carry out the prescribed user gesture after the approach area portion 8 has been walked through, in particular in the confirmation area portion 11.

In various embodiments, a control arrangement 3 for a motorized flap arrangement 1 of a motor vehicle 2 is provided. The control arrangement 3 checks the sensor values detected by means of the radar sensor 6 for the fulfillment of prescribed user action criteria.

The essential point here is that, in a user tracking routine, the control arrangement 3 performs a time-dependent association of detected sensor values with the user B, that the control arrangement 3 determines a user trajectory for the position of the user B from the time dependence of the sensor values associated with the user B, and that at least one user action criterion is defined by the fact that the user trajectory complies with a trajectory specification. Reference is made to all statements relating to the proposed method.

In various embodiments, a motor vehicle 2 designed for carrying out the method is provided. Reference is made, also in this regard, to all statements relating to the proposed method.

1. A method for operating a motorized flap arrangement of a motor vehicle, wherein a control arrangement for activating a motorized drive arrangement assigned to the flap arrangement and a radar sensor coupled to the control arrangement are provided, wherein sensor values relating to a user action of a user situated outside of the motor vehicle are detected by the radar sensor,
wherein the detected sensor values are checked, by the control arrangement, for the fulfillment of prescribed user action criteria, wherein, depending on the result of the check, the user action detected via the sensor values is rejected or is qualified as a valid user action, and
wherein, upon detection of a valid user action, the control arrangement activates the drive arrangement for the motorized displacement of the flap arrangement,
wherein,
in a user tracking routine, a time-dependent association of detected sensor values with the user is performed by the control arrangement, a user trajectory for the position of the user is determined from the time dependence of the sensor values associated with the user, and at least one user action criterion is defined by the fact that the user trajectory complies with a trajectory specification.

2. The method as claimed in claim 1, wherein the user tracking routine is triggered upon fulfillment of a prescribed user recognition criterion.

3. The method as claimed in claim 2, wherein the user recognition criterion is at least partially defined by the fact that speed values of an object detected in the sensor values represent a prescribed approach toward the motor vehicle.

4. The method as claimed in claim 1, wherein, in the user tracking routine, a plurality of radar targets detected in the sensor values are combined in accordance with a cluster model to form a cluster target, the cluster target is associated with the user in a time-dependent manner and the user trajectory is determined on the basis of the cluster target.

5. The method as claimed in claim 1, wherein the trajectory specification is at least partially defined by the fact that the user trajectory runs within a prescribed approach area portion at least over a period of time.

6. The method as claimed in claim 5, wherein the trajectory specification is at least partially defined by the fact that the approach area portion is or are passed through by the user trajectory within a prescribed approach period.

7. The method as claimed in claim 5, wherein a confirmation area portion is provided between the motor vehicle and the approach area portion and the trajectory specification meets the user trajectory in the approach area portion.

8. The method as claimed in claim 1, wherein a plurality of motorized flap arrangements are provided, for which an approach area portion is prescribed in each case, and, with the qualification as a valid user action, using the user trajectory and the approach area portions the user action is assigned to one of the flap arrangements for the motorized displacement.

9. The method as claimed in claim 1, wherein, in the user tracking routine, the detected, time-dependent sensor values are associated with the user on the basis of a mathematical estimation model.

10. The method as claimed in claim 1, wherein one of the actuation criteria is defined by the fact that an authentication unit of the user is detected by the control arrangement, wherein the detection of the sensor values by the control arrangement is triggered upon detection of the authentication unit, and/or that the user recognition criterion is at least partially defined by the fact that a position value, determined from the sensor values of the radar sensor, of the object detected in the sensor values corresponds to a position value of the authentication unit determined by the detection of the authentication unit.

11. The method as claimed in claim 1, wherein the radar sensor is designed for a vehicle-to-X application, wherein the radar sensor is designed for a vehicle-to-vehicle application in the driving mode and is used for detecting the sensor values relating to the user action when the motor vehicle is parked, and/or the radar sensor is designed to detect objects in the displacement region of the motorized displacement of the flap arrangement.

12. The method as claimed in claim 1, wherein one of the user action criteria relates to the recognition of a prescribed user gesture, wherein the prescribed user gesture is to be carried out after the approach area portion has been walked through, in particular in the confirmation area portion (11).

13. A control arrangement for a motorized flap arrangement of a motor vehicle, wherein the control arrangement is designed to activate a motorized drive arrangement assigned to the flap arrangement and to couple to a radar sensor, wherein the radar sensor detects sensor values relating to a user action of a user situated outside of the motor vehicle,
wherein the control arrangement checks the detected sensor values for the fulfillment of prescribed user action criteria and, depending on the result of the check, rejects the user action detected via the sensor values or qualifies it as a valid user action, and wherein, upon detection of a valid user action, the control arrangement activates the drive arrangement for the motorized displacement of the flap arrangement,
wherein,
in a user tracking routine, the control arrangement performs a time-dependent association of detected sensor values with the user, the control arrangement determines a user trajectory for the position of the user from the time dependence of the sensor values associated with the user, and at least one user action criterion is defined by the fact that the user trajectory complies with a trajectory specification.

14. A motor vehicle for carrying out the method as claimed in claim 1.

15. The method as claimed in claim 1, wherein the user tracking routine is triggered upon fulfillment of a prescribed user recognition criterion, wherein the user recognition criterion is at least partially defined by the fact that the object detected via the sensor values complies with an expansion specification representative of a user.

16. The method as claimed in claim 3, wherein the speed values represent an approach exceeding a prescribed minimum speed.

17. The method as claimed in claim 4, wherein the cluster model is based on the determination of a cluster target using statistical values of radar targets, selected using position values, amplitude values and/or speed values.

18. The method as claimed in claim 5, wherein the user trajectory passes through at least two prescribed approach windows of the approach area portion.

19. The method as claimed in claim 7, wherein the trajectory specification is at least partially defined by the fact that the user trajectory experiences a stopping motion in the confirmation area portion, wherein a maximum speed is not reached and/or a minimum residence time in the confirmation area portion is exceeded.

20. The method as claimed in claim 9, wherein the estimation model is based on an alpha-beta filter, a Kalman filter and/or a nonlinear filter.
